(19) United States
(12) Patent Application Publication
(10) Pub. No.: US 2012/0322479 A1
(43) Pub. Date: Dec. 20, 2012

(54) COMMUNICATION LINK MONITORING AND FAILURE HANDLING IN A NETWORK CONTROLLED DEVICE-TO-DEVICE CONNECTION

(75) Inventors: Sami-Jukka Hakola, Kempele (FI); Timo Koskela, Oulo (FI); Samuli Turtinen, Li (FI)

(73) Assignee: Renesas Mobile Corporation

(21) Appl. No.: 13/160,912

(22) Filed: Jun. 15, 2011

(51) Int. Cl. H04W 24/04

(52) U.S. Cl. 455/507

(57) ABSTRACT

A method and apparatus are provided to facilitate the selection of a monitoring device for a communication link in device-to-device communications, such as non-cellular communications or cellular communications in a licensed exempt band. A method and apparatus determine the reception resources available for use by a first telecommunications device, and ascertain the reception resources available for use by a second telecommunications device. The method and apparatus then select either the first telecommunications device or the second telecommunications device as a monitoring device to monitor the communications link. The method and apparatus may also change the monitoring device to the other telecommunications device based upon a change in the balance of reception resources of the first telecommunications device or the second telecommunications device.

### TECHNOLOGICAL FIELD

Embodiments of the present invention relate generally to wireless communication technology and, more particularly, to a method and apparatus for providing communication link monitoring and failure handling in a network controlled device-to-device connection.

### BACKGROUND

Currently, when pairs of devices communicate in a device-to-device connection, one device is identified as a master device in a master-slave type configuration for purposes of monitoring the communication link between the two devices. The master device is usually selected to be the device having better network connectivity, better radio capability, better processing power, higher battery availability, etc. However, the monitoring device generally remains in that role regardless of changing performance or capability in the future. Therefore, a more flexible and improved mechanism would be desirable for selecting one of the devices in a device-to-device communication system for purposes of handling failures.

### BRIEF SUMMARY OF EXAMPLE EMBODIMENTS

A method and apparatus are therefore provided in accordance with an example embodiment to facilitate the selection of a monitoring device for a communication link, such as a radio link, in a device-to-device communication system, including without limitation a non-cellular communication system or a cellular communication system in a license exempt band. Among the device-to-device communication systems which may utilize the embodiments of the present invention are also machine-to-machine communications that may further leverage communications within the license exempt band.

In one example embodiment, a method is provided that includes determining reception resources available for use by a first telecommunications device to monitor a communications link between the first telecommunications device and a second telecommunications device. These reception resources may include, without limitation, the amount of reference signals received by a telecommunications device or the level of connectivity of a telecommunications device within a telecommunications network. The method may also ascertain reception resources available for use by the second telecommunications device to monitor the communications link between the first telecommunications device and the second telecommunications device. The method may select one of the first telecommunications device or the second telecommunications device as a monitoring device to monitor the communications link. For example, the method may select the first telecommunications device or the second telecommunications device as the monitoring device based at least in part on a balance of reception resources between the first telecommunications device and the second telecommunications device, or another type of reconfiguration of reception resources between telecommunication devices. The method may then subsequently change selection of the monitoring device to the other of the first telecommunications device or the second telecommunications device to monitor the communications link following initial selection of one of the first telecommunications device or the second telecommunications device as the monitoring device.

The method may change the selection to the other of the first telecommunications device or the second telecommunications device based at least in part on a change in balance of reception resources of the first telecommunications device and the second telecommunications device. The method may also change the selection to the other of the first telecommunications device or the second telecommunications device in response to a message received from a base station in communication with the first telecommunications device and the second telecommunications device. The method may change the selection to the other of the first telecommunications device or the second telecommunications devices in response to the first telecommunications device, the second telecommunications device, or the base station identifying a change in balance of reception resources of the first telecommunications device or the second telecommunications devices.

In a cluster communication network, changing responsibility may be based, at least in part on, receiving a failure indication from a cluster head in a cluster communication network, which may include a cluster head and one or more nodes. These nodes may comprise any type of computer device or other cluster member which may operate in a cluster environment. The failure indication from the cluster head may be based at least in part on a communication link failure between nodes or between a node and the cluster head. The failure indication may also be based at least in part on a reference signal received from a cluster head in a cluster communication network in response to detecting a communication link failure.

The method may also cause timing information to be transferred from the monitoring device to the other of the first telecommunications device or the second telecommunications devices that then serves as the subsequent monitoring device. This timing information may include, without limitation, counters or timing values, and may be transferred in any number of ways, including without limitation, in accordance with the user plane packet data convergence protocol (PDCP) or by adding a control field into a subsequent, e.g., the next, PDCP protocol data unit (PDU) to be sent to the lower levels, and eventually the other device, in the device-to-device connection.

According to an example embodiment of the present invention, the first telecommunications device and the second telecommunications device may comprise, without limitation, any electronic device configured to transfer information across a distance, including without limitation, mobile terminals, such as cellular telephones, dual mode cellular terminals or any other portable electronic device configured to communicate information electronically, or any network entity, e.g., a base station.

In another example embodiment, a method is provided that includes monitoring at a first telecommunications device a communications link between the first telecommunications device and a second telecommunications device and changing responsibility for monitoring the communications link to the second telecommunications device. The method may change responsibility based at least in part on available resources of the first telecommunications device and the second telecommunications device. The method may identify reception resources available for a first telecommunications device and a second telecommunications device prior to changing responsibility for monitoring the communications link. The method may also cause a message to be communicated that establishes a communication session between the at least two telecommunications devices. According to the example embodiment of the present invention, the at least two telecommunications devices may comprise, without limitation, any electronic device configured to transfer information across a distance, including without limitation, mobile terminals, such as cellular telephones, dual mode cellular terminals, or any portable electronic device configured to communicate information electronically, or any telecommunications infrastructure such as a network entity, e.g., a base station.

In a further embodiment, an apparatus is provided that includes at least one processor and at least one memory including computer program code with the at least one memory and the computer program code being configured to, with the at least one processor, cause the apparatus to at least determine reception resources available for use by a first telecommunications device to monitor a communications link between the first telecommunications device and a second telecommunications device, ascertain the reception resources available for use by the second telecommunications device to monitor the communications link between the first telecommunications device and the second telecommunications device and select one of the first telecommunications device or the second telecommunications device as a monitoring device to monitor the communications link. The at least one memory and the computer program code may also be configured to, with the at least one processor, cause the apparatus to select one of the first telecommunications device or the second telecommunications device as a monitoring device to monitor the communications link comprises selecting the first telecommunications device or the second telecommunications device as the monitoring device based at least in part on the balance of reception resources of each of the first telecommunications device and the second telecommunications device. The apparatus in the multiple embodiments of the present invention may comprise, without limitation, a device in a device-to-device connection, or a base station in a telecommunications network.

In an example embodiment, the at least one memory and the computer program code are configured to, with the at least one processor, cause the apparatus to identify a change in the balance of reception sources between the first telecommunications device or the second telecommunications device. The at least one memory and the computer program code may be configured to, with the at least one processor, cause the apparatus to select the other of the first telecommunications device or the second telecommunications device based at least in part on a change in balance of reception resources of the first telecommunications device and the second telecommunications device. Additionally or alternatively, the at least one memory and the computer program code may be configured to, with the at least one processor, cause the apparatus to select the other of the first telecommunications device or the second telecommunications device in response to a message received from a base station in communication with the first telecommunications device and the second telecommunications device.

The at least one memory and the computer program code are configured to, with the at least one processor, cause the apparatus to select the other of the first telecommunications device or the second telecommunications device in response to a change in balance of reception resources of the first telecommunications device or the second telecommunications device to serve as a subsequent monitoring device. With the selection of the other of the first and second communication devices, the one of the first and second communication devices that previously served as the monitoring device would no longer function as the monitoring device. The at least one memory and the computer program code may be configured to, with the at least one processor, cause the apparatus to cause timing information to be transferred from the monitoring device to the subsequent monitoring device. The timing information may include counter and timing data. The timing information may be transferred any number of ways, including without limitation, transferring the timing information via a particular time window, transferring the timing information onto the user plane in a cross-layer and cross-plane signaling from the control plane radio resource control (RRC) protocol to the user plane PDCP protocol with a control field being added in a subsequent, e.g., the next, PDCP PDU to be sent to the lower layers and the subsequent monitoring device.

The apparatus may comprise, without limitation, any telecommunications device, including the first telecommunications device, the second telecommunications device, any other mobile terminal, or a base station in a telecommunications network. Further, the first telecommunications device and the second telecommunications device may comprise, without limitation, any telecommunications device as defined herein, including without limitation, mobile terminals.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is one example of a communications system according to an embodiment of the present invention.

FIG. 2 is a block diagram of an apparatus from the perspective of the base station in accordance with an example embodiment of the present invention.

FIG. 3 is a block diagram of an apparatus from the perspective of a terminal in accordance with an embodiment of the present invention.

FIG. 4 is a signaling diagram illustrating messages exchanged between a base station, a first telecommunications device, and a second telecommunications device in accordance with an example embodiment of the present invention.

FIG. 5 is a flowchart illustrating the selection of the monitoring device performed in accordance with an example embodiment of the present invention from the perspective of a base station or one of the devices in the device-to-device connection.

FIG. 6 is a flowchart illustrating the changing of the monitoring device performed in accordance with an example embodiment of the present invention from the perspective of a base station or one of the devices in the device-to-device connection.

FIG. 7 illustrates another example of a communications system according to an embodiment of the present invention that provides for machine type communications.

FIG. 8 illustrates another example of a communications system according to an embodiment of the present invention that provides for machine type communications.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, a telecommunications device may include but is not limited to the following: (a) wired and wireless telephones (b) satellite telephones (c) personal communication devices; (d) electronic devices configured to share content in a local area network (LAN); (e) electronic gaming devices including, but not limited to, Nintendo® Gameboy® devices; (f) electronic music devices including, but not limited to, Apple® iPod® devices; (g) telecommunications network infrastructure equipment, including but not limited to a base station; (h) dual-mode cellular terminals which utilizes a cellular network and a non-cellular network; (i) other types of mobile terminals (j) any machines configured for wireless communications in various applications, including but not limited to, smart homes, smart metering, fleet management, remote healthcare, or access network operation management; or (k) any device used in a device-to-device connection.

The term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform the various functions) and (c) to circuits, such as microprocessor(s) or a portion of microprocessor(s), that require software or firmware for operation, even if the software or firmware is not present.

This definition of ‘circuitry’ applies to all uses of this term in this application, including any claims. As a further example, as used in this application, the term “circuitry” would also cover an implementation of merely a processor (or multiple processors) or portion of a processor and its (or their) accompanying software and/or firmware. The teen “circuitry” would also cover, for example and if applicable to the particular claim element, a baseband integrated circuit or applications processor integrated circuit for a mobile phone or similar integrated circuit in a server, a cellular network device, or other network device.

“Reception resources” may include, in a telecommunications environment, the amount of reference signals available to one or more telecommunications devices for use in monitoring a communications link. Each time-frequency resource has a certain amount of reference signals or symbols. Then, the more receiving resources (also referred to as “RX” resources), the more receiving reference symbols or signals. In a cluster communication network, the amount of reception resources may comprise the level of connectivity in the cluster communication network. The levels of connectivity may comprise partial connectivity, which comprises a connection between the nodes of the cluster communication network and the cluster head, or full connectivity, which comprises all of the nodes in the cluster communication network having a connection to each other, along with the cluster head. In case of partial connectivity, nodes act in a monitoring role, and each node monitors the communication link to the cluster head. The cluster head may then send continuous or periodic control signaling to each cluster member or node, wherein the continuous or periodic signaling may be used for, without limitation, communication link monitoring. With full connectivity, each node monitors the communication link from any other node. In general, in cluster communication, the role of monitoring device cannot be derived based on reception resources totally as in pure device to device communication among two devices.

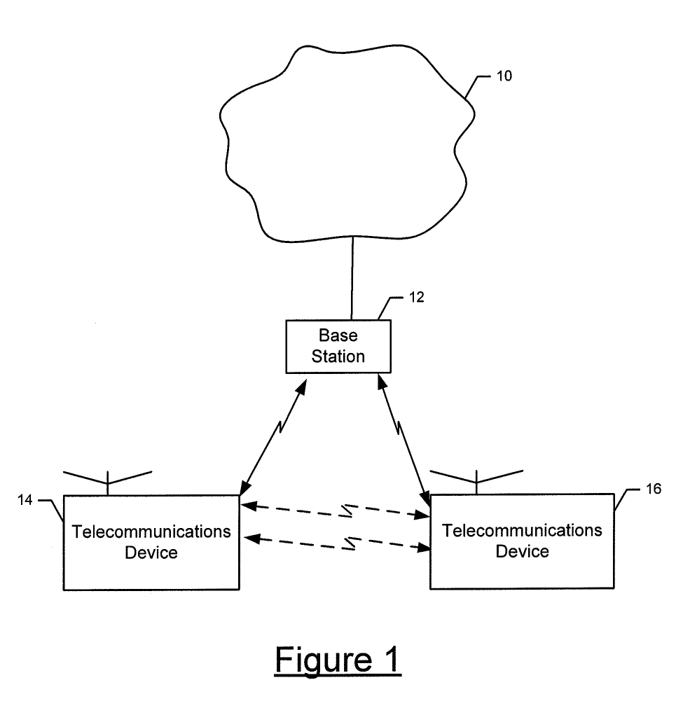

In accordance with an example embodiment of the present invention, a communication system is provided in which a network entity, such as a base station, such as an access point, an evolved Node B (eNB) or the like, may communicate with a plurality of terminals in the licensed spectrum in order to coordinate device-to-device communication between the terminals in a license exempt band, such as within the Industrial, Scientific and Medical (ISM) band or the television white space (TVWS) band. While a communications system that provides coordination of device-to-device communication may be configured in various different manners, FIG. 1 illustrates a generic system diagram in which a telecommunications device, such as a mobile terminal, e.g., a cellular telephone, may communicate in a licensed spectrum with the network 10, such as by the exchange of cellular signals as shown in the solid lightning bolts in FIG. 1, and in a license exempt band, such as, but not limited to, the ISM band, with another telecommunications device as shown by the dashed lightning bolts. As shown in FIG. 1, an embodiment of a system in accordance with an example embodiment of the present invention may include a first telecommunications device 14 and a second telecommunications device 16 that may each be capable of communication, such as cellular communication, in the licensed band with a network 10 (e.g., a core network) and more directly with one another in a license exempt band. While the network may be configured in accordance with Long Term Evolution (LTE), the network may employ other mobile access mechanisms such as wideband code division multiple access (W-CDMA), CDMA2000, global system for mobile communications (GSM), general packet radio service (GPRS), LTE-Advanced (LTE-A) and/or the like. In other example embodiments, either first telecommunications device 14 or second telecommunications device 16 may comprise any other telecommunications device other than a mobile terminal, including without limitation a base station in a telecommunications network.

The network 10 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network. One or more telecommunications devices such as the telecommunications devices 14 and 16 may be in communication with each other or other devices via the network. In some cases, each of the communication terminals may include an antenna or antennas for transmitting signals to and for receiving signals from a base station, such as an access point, node B, eNB or the like (hereinafter generically referenced as a base station 12). The base station could be, for example, part of one or more cellular or mobile networks or public land mobile networks (PLMNs). In turn, other devices such as processing devices (e.g., personal computers, server computers or the like) may be coupled to the terminals via the network.

In some example embodiments, the first and second telecommunications devices 14, 16 may be mobile terminals such as, for example, a mobile telephone, portable digital assistant (PDA), pager, laptop computer, or any of numerous other hand held or portable communication devices, computation devices, content generation devices, content consumption devices, or combinations thereof. Alternatively, the first and second telecommunications devices may be fixed communication devices that are not configured to be mobile or portable. In either instance, the telecommunications devices may include one or more processors that may define processing circuitry either alone or in combination with one or more memories. The processing circuitry may utilize instructions stored in the memory to cause the terminals to operate in a particular way or execute specific functionality when the instructions are executed by the one or more processors. The telecommunications devices may also include communication circuitry and corresponding hardware/software to enable communication with other devices and/or the network 10.

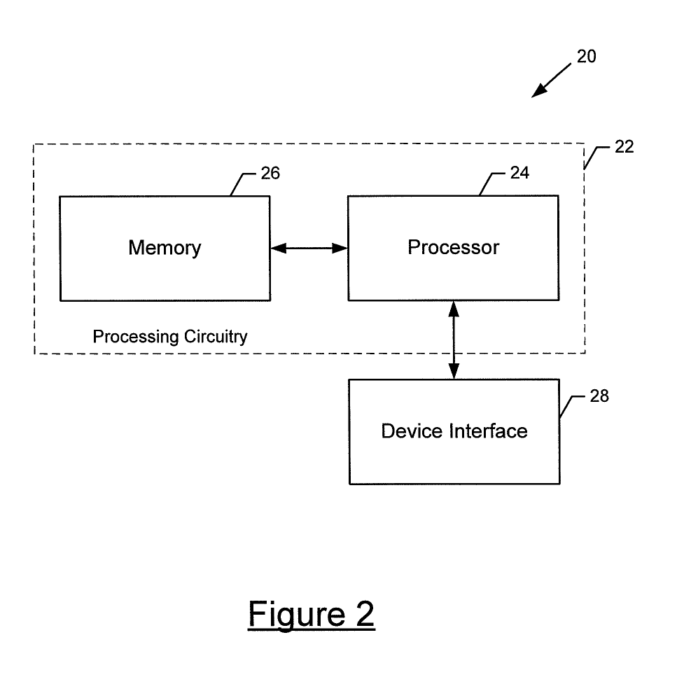

The base station 12 may be embodied as or otherwise include an apparatus 20 as generically represented by the block diagram of FIG. 2. In this regard, the apparatus may be configured to communicate with the sets of first and second telecommunications devices 14, 16 to selectively establish device-to-device communication. While one embodiment of the apparatus is illustrated and described below, it should be noted that the components, devices or elements described below may not be mandatory and thus some may be omitted in certain embodiments. Additionally, some embodiments may include further or different components, devices or elements beyond those shown and described herein. For example, without limitation, first and second telecommunications devices 14 and 16 may also comprise base stations.

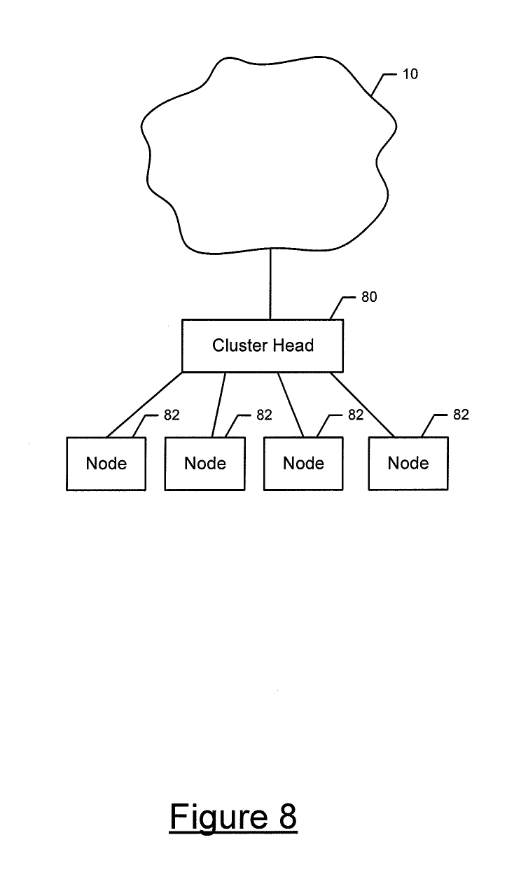

As shown in FIG. 2, the apparatus 20 may include or otherwise be in communication with processing circuitry 22 that is configurable to perform actions in accordance with example embodiments described herein. The processing circuitry 22 may be configured to perform data processing, application execution and/or other processing and management services according to an example embodiment of the present invention. In some embodiments, the apparatus 20 may comprise a node 82 or cluster head 80 in a cluster communication network 10 as shown in FIG. 8. In other embodiments, the apparatus or the processing circuitry 22 may be embodied as a chip or chip set. In other words, the apparatus or the processing circuitry 22 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry 22 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry 22 may be embodied as a circuit chip (e.g., an integrated circuit chip) configured (e.g., with hardware, software or a combination of hardware and software) to perform operations described herein in relation to the base station 12.

The device interface 28 may include one or more interface mechanisms for enabling communication with other devices, such as the first and second telecommunications devices 14, 16, and/or networks, such as network 10. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem, for enabling communications with the sets of first and second terminals.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

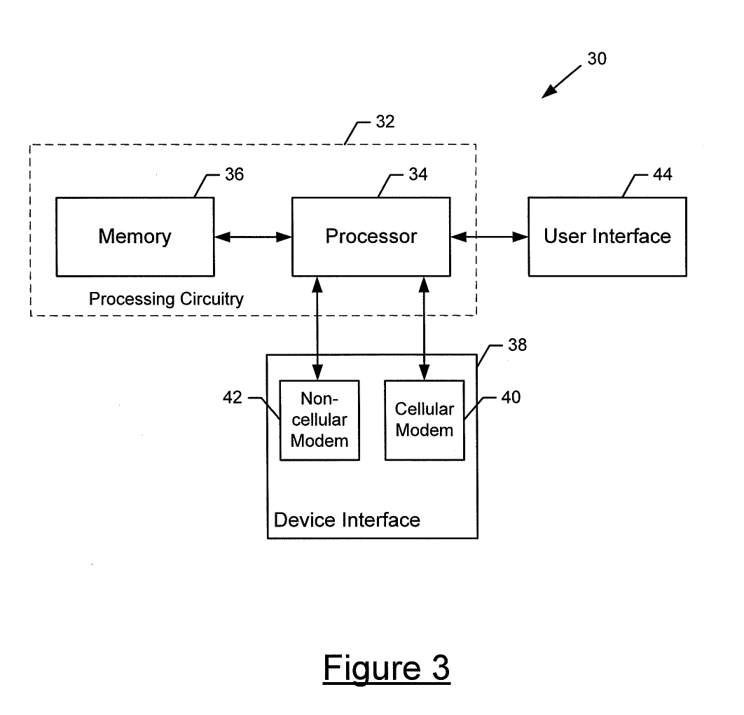

In one embodiment, the first and/or second telecommunications devices 14, 16 may be embodied as or otherwise include an apparatus 30 as generically represented by the block diagram of FIG. 3. In this regard, the apparatus may be configured to provide for communications in the licensed spectrum, such as cellular communications, with the base station 12 or another terminal and device-to-device communications in the license exempt band, such as non-cellular communications, with another terminal. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with processing circuitry 32 that is configurable to perform actions in accordance with example embodiments described herein. The processing circuitry 32 may be configured to perform data processing, application execution and/or other processing and management services according to an example embodiment of the present invention. In some embodiments, the apparatus 30 may comprise a node 82 or cluster head 80 in a cluster communication network 10 as shown in FIG. 8. In other embodiments, the apparatus or the processing circuitry 32 may be embodied as a chip or chip set. In other words, the apparatus or the processing circuitry 32 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry 32 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry 32 may be embodied as a circuit chip (e.g., an integrated circuit chip) configured (e.g., with hardware, software or a combination of hardware and software) to perform operations described herein. However, in some embodiments taken in the context of some telecommunications devices such as a mobile terminal, the processing circuitry 32 may be embodied as a portion of a mobile computing device or other mobile terminal.

The user interface 44 (if implemented) may be in communication with the processing circuitry 32 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 for supporting communications in the licensed spectrum, such as communications with the base station 12, and a non-cellular modem 42 for supporting communications in the license exempt band, such as non-cellular communications, e.g., communications in the ISM band or the TVWS band, with other terminals.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

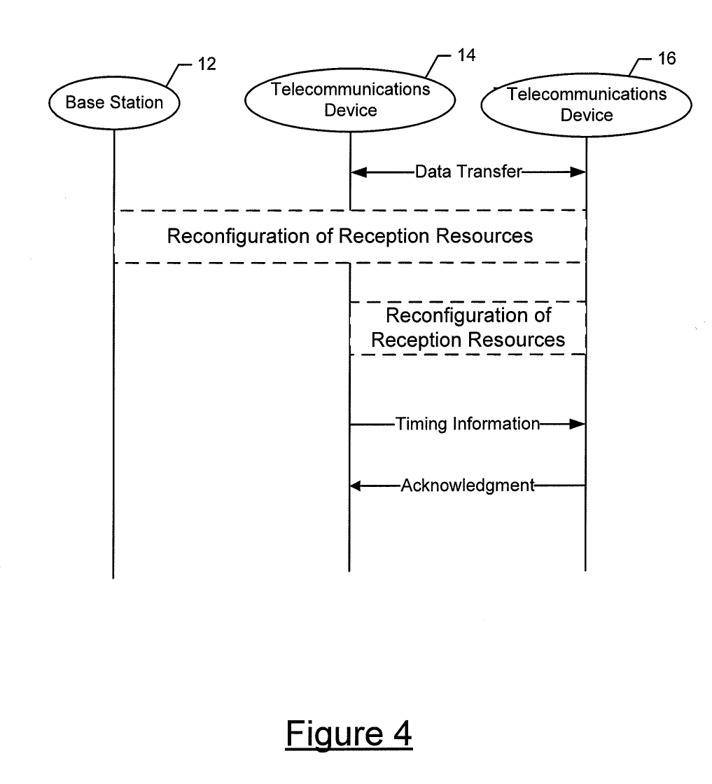

In an active device-to-device connection, as shown in FIG. 4, data may be transferred directly between telecommunications device 14 and telecommunications device 16. This device-to-device connection may be caused by facilitating the establishment of a communication link between two devices, for example, in a non-cellular communication network or in a license exempt band. The device-to-device connection may also involve a machine-to-machine connection in a machine network as shown in FIG. 8 that may further leverage communications within the license exempt band.

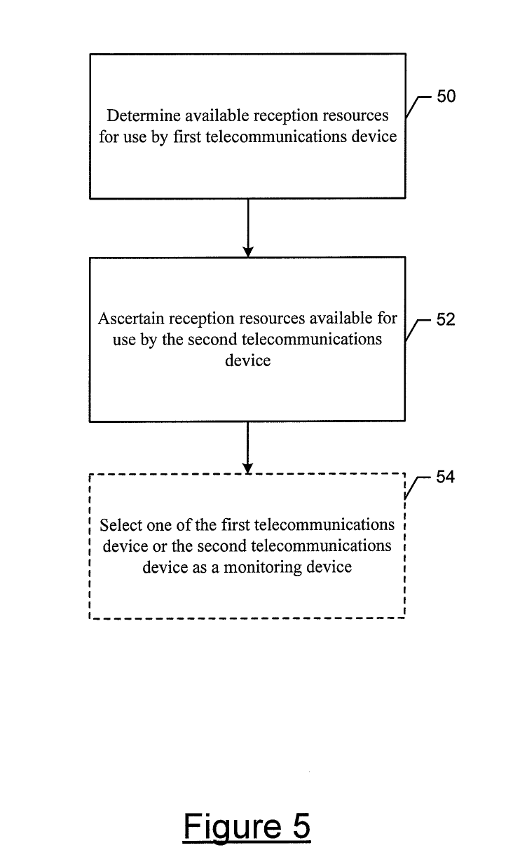

For purposes of illustration, FIG. 4 illustrates telecommunications device 14 as the initially selected monitoring device with the telecommunications device 14 being selected as the monitoring device by, for example, the method discussed in FIG. 5. Once the telecommunications device 14 is selected as the monitoring device, reconfiguration of reception resources may occur between the base station 12 and telecommunications device 14, and/or between base station 12 and telecommunications device 16. The reconfiguration of reception resources may comprise a reconfiguration of resource sharing balance, which in turn may involve the base station 12 changing the configuration of the amount of reception resources for each telecommunications device 14 or 16 in the device-to-device connection. The configuration may be changed based on the buffer status and the priorities of each telecommunications device for the device-to-device connection. Reception resources may exist to exclusively monitor the communication link, or reception resources may be multiplexed with data symbols to monitor the communication link.

Alternatively, the reconfiguration of reception resources may occur between the telecommunications devices 14 and 16. These reception resources may include, without limitation, the amount of signals received by a telecommunications device or the level of connectivity of the telecommunications device to a network. This reconfiguration of reception resources may also be associated with a resource reconfiguration indication sent from either the base station 12, or either telecommunications device 14 and 16, to the monitoring device (which may comprise telecommunications device 14 or 16).

After the reconfiguration of reception resources, for purposes of illustration and without limitation, FIG. 4 illustrates the selection of telecommunications device 16 as the subsequent monitoring device, such as in response to telecommunications device 16 now having more reception resources to devote to monitoring of the communications link than does telecommunications device 14 even though telecommunications device 14 had more reception resources during the initial selection of the monitoring device. Once telecommunications device 16 is selected as the subsequent monitoring device, telecommunications device 14 may terminate or otherwise transition out of its prior role as the monitoring device. Timing information may be transferred from telecommunications device 14 in its role as the monitoring device to telecommunications device 16 as the subsequent monitoring device. This transfer of timing information, which may include counters and timing data, may occur within a certain time window. For example, the timing information may be transferred as a new device-to-device message (including without limitation a radio resource control (RRC) message) or the timing information could be transferred into a user plane, such as via cross-layer and cross-plane signaling, from the control plane RRC protocol to the user plane PDCP protocol. This process may involve adding a control field into the next PDCP PDU to be sent to lower layers, and then eventually, to the subsequent monitoring device. Once this timing information is transferred from the monitoring device (telecommunications device 14) to the subsequent monitoring device (telecommunications device 16), an acknowledgment may be sent from the subsequent monitoring device to the monitoring device acknowledging receipt of the timing information.

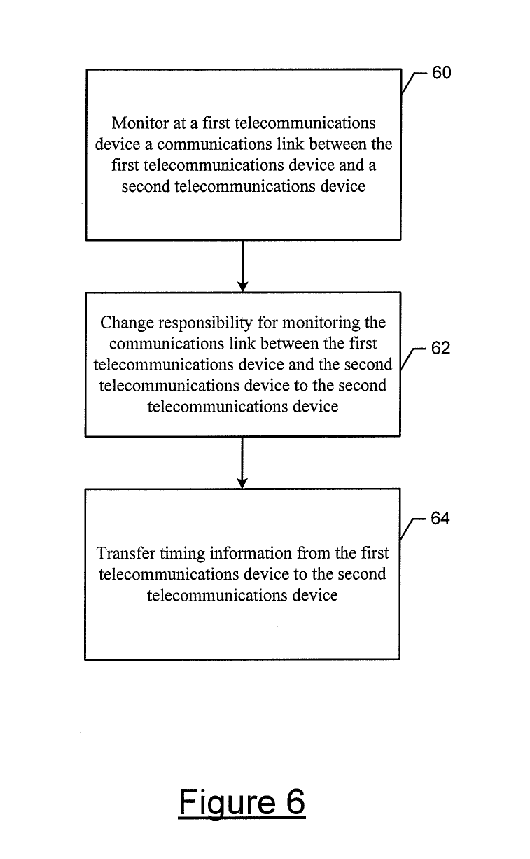

While an embodiment of the present invention has been described above in conjunction with FIG. 4, flowcharts of the operations performed from the perspective of the base station 12, telecommunications device 14 and telecommunications device 16 are now provided with reference to FIGS. 5 and 6, respectively. It will be understood that each block of the flowcharts, and combinations of blocks in the flowcharts, may be implemented by various means, such as hardware, firmware, processor, circuitry, and/or other device associated with execution of software including one or more computer program instructions. For example, one or more of the procedures shown by the flowcharts may be embodied by computer program instructions. In this regard, the computer program instructions which embody the procedures depicted by the flowcharts may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special-purpose hardware-based computer systems which perform the specified functions, or combinations of special purpose hardware and computer instructions.

FIG. 5 is a flowchart illustrating the selection of the monitoring device performed in accordance with an example embodiment of the present invention from the perspective of a base station 12 or one of the telecommunications devices 14 or 16 in the device-to-device connection. With reference to block 50 of FIG. 5, an apparatus 20 that may be embodied by or otherwise associated with base station 12 or telecommunications devices 14 or 16 may include means, such as the processing circuitry 22, a processor 24, a device interface 28 or the like, for determining the available reception resources for use by first telecommunications device. This determination may involve the base station assigning the reception resources, or indicating the resource sharing balance between devices from which it can be implicitly derived which device has more reception resources, as D2D communication utilizes time division duplex (TDD) transmission mode. This determination may be performed by either one of the telecommunication devices 14 or 16 in the device-to-device connection, or by any other telecommunications device connectively coupled to telecommunication devices 14 and 16, including without limitation, a base station in a telecommunications network. Further, in a cluster communication network, this determination may be performed by the cluster head or by other nodes in the cluster communication network.

The apparatus may also include means, such as the processing circuitry 22, a processor 24, a device interface 28 or the like, for ascertaining the reception resources available for use by the second telecommunications device, which may comprise the base station assigning the resource sharing balance among the telecommunications devices. See block 52. Either one of the telecommunication devices 14 or 16 in the device-to-device connection, or any other telecommunications device connectively coupled to telecommunication devices 14 and 16, including without limitation, a base station in a telecommunications network, may ascertain the reception resources available for use by the second telecommunications device.

Following the determination of available reception resources for use by the first telecommunications device and the reception resources available for use by the second telecommunications device, the apparatus 20 may also include means, such as the processing circuitry 22, the processor 24, the device interface 28, or the like, for selecting one of the first telecommunications device or the second telecommunications device as a monitoring device. In one embodiment, the telecommunications device having more reception resources available for use in conjunction with monitoring of the communications link between the first and second telecommunications devices may be selected as the monitoring device. By selecting the telecommunications device having more reception resources available for use in conjunction with monitoring of the device-to-device communications link, the communications link may be monitored in more detail and more thoroughly without disrupting other signaling supported by the communications link. In a cluster communication network, this monitoring device that is selected may comprise one of the nodes in the cluster communication network.

FIG. 6 is a flowchart illustrating the changing of the monitoring device performed in accordance with an example embodiment of the present invention from the perspective of a base station or one of the devices in the device-to-device connection. With reference to block 60 of FIG. 6, an apparatus 20 that may be embodied by or otherwise associated with a base station 12 may include means, such as processing circuitry 22, a processor 24, a device interface 28 or the like, for monitoring, at a first telecommunications device, a communications link between the first telecommunications device and a second telecommunications device. Monitoring the communication link may comprise monitoring the quality of received reference symbols by the communication devices, and could be performed in a similar manner as the RRC_CONNECTED radio link monitoring process by cellular mode devices as mentioned in 3GPP TS36.214 V8.0.0.

Following the monitoring at the first telecommunications device a communication link between the first telecommunications device and a second telecommunications device, the apparatus 20 may also include means, such as the processing circuitry 22, the processor 24, the device 28, or the like, for changing responsibility for monitoring the communications link between the first telecommunications device and the second telecommunications device from the first telecommunications device to the second telecommunications device. See block 62. To change responsibility, a reconfiguration message may be sent by the base station and received by a telecommunications device.

In response to changing responsibility for monitoring the communications link between the first telecommunications device and the second telecommunications device to the second telecommunications device, the apparatus 20 may include means, such as processing circuitry 32, the processor 34, the device interface 38, the non-cellular modem 42 or the like for causing timing information to be transferred from the first telecommunications device to the second telecommunications device. The timing information is transferred from the first telecommunications device to the second telecommunications device to provide a seamless transition for monitoring purposes and to insure that the monitoring is done in the same fashion by each of the monitoring devices. This timing information may include, without limitation, counters and timing data, and may be transferred any number of ways, including but not limited to, transfer as a new MAC CE field or via the user plane PDCP PDU. Causing timing information to be transferred via the user plane PDCP PDU may involve, without limitation, a cross-plane transfer from a radio resource control device to the user plane PDCP PDU or any other method of causing timing information to be transferred from one telecommunications device to another telecommunications device.

To avoid a “ping-pong” or hysteresis effect in the event of frequently changing reception resource configurations, certain network controlled parameters and signaled parameters may be defined that would allow for certain small-scale fluctuations in reception resource configurations or balances before triggering a reassignment of the monitoring device to another telecommunications device. These network controlled parameters and signaled parameters may include, without limitation, a requirement that the balance of the reception resources between the telecommunications devices 14 and 16 not only change such that the telecommunications device that is the monitoring device have fewer reception resources available for monitoring of the communications link than another telecommunications device, but that the available reception resources of the telecommunications device that is the monitoring device fall below those of the other telecommunications device by at least a predefined amount and/or a predefined percentage prior to changing the monitoring device.

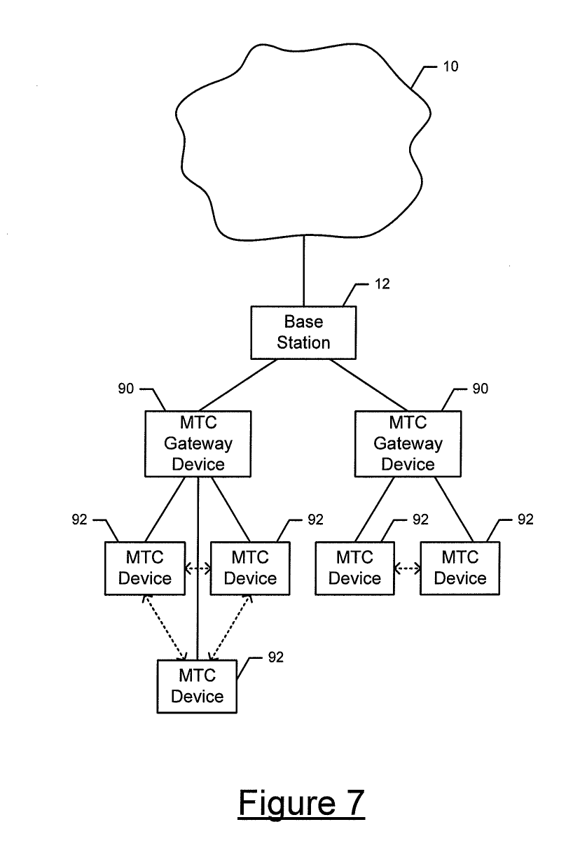

Although device-to-device connections may be established between a variety of different types of first and second telecommunications devices 14, 16, the first and second telecommunications devices of one embodiment may be a machine type communication (MTC) gateway 90 and an MTC device 92, each of which are configured to communicate in both the licensed spectrum, such as via respective cellular modems, and in the unlicensed spectrum, such as via respective non-cellular modems, such as WiFi modems. As shown in FIG. 7, a system in accordance with this embodiment may include a base station 12 that is in communication with one or more MTC gateways. Each MTC gateway may communicate with a plurality of MTC devices within a capillary network such as via non-cellular communications, e.g., ZigBee, Bluetooth, or communications in accordance with the IEEE 802.15 standard. The MTC gateway, however, not only can communicate with the MTC devices via local connectivity technologies such as non-cellular communications, but may also communicate with the network 10, such as the base station, via cellular connections. Thus, the MTC gateway device may serve as an agent for the MTC devices within the capillary network to communicate via the network. As such, the MTC gateway device may perform procedures such as authentication, authorization, registration, management and provisioning on behalf of the MTC devices within the respective capillary network.

In an instance in which at least one of the MTC devices 92 within a capillary network not only may communicate via non-cellular signals, such as via non-cellular modems, but also may communicate with cellular signals, such as via cellular modem, the respective MTC device and the MTC gateway device 90 may be considered a respective pair of first and second terminals 14, 16 and may be configured by the base station 12 to establish device-to-device communications, such as machine-to-machine communications, there between. For example, a non-cellular connection via WiFi may be established between the respective MTC device and the MTC gateway for such machine-to-machine communication, while other communications within the capillary network such as between the MTC gateway device and other MTC devices may be conducted via other non-cellular communication channels such as ZigBee. In another example, a cellular connection may be established between the respective MTC device and the MTC gateway for such machine-to-machine communication, while other communications within the capillary network such as between the MTC gateway device and other MTC devices may be conducted via other non-cellular communication channels such as WiFi or ZigBee. As such, the method, apparatus and computer program product of an example embodiment of the present invention may facilitate improvements with respect to machine-to-machine communications.

In another example embodiment of the present invention in a cluster communication network 10 including one or more nodes 82 and a cluster head 80, a method is provided that includes one or more nodes 82 in the cluster communication network 10 monitoring the communication link quality between one or more of the other nodes 82, or other cluster members, and the cluster head 80. See FIG. 8. These nodes 82 may comprise, without limitation, one or more telecommunications devices with each node 82 supporting a communication link to at least one other node 82 in the cluster communication network 10. The method may change responsibility for any of the nodes 82 monitoring the communications link in the cluster communication network 10 to another node 82. The method may change responsibility based at least in part on receiving a failure indication from one of the nodes 82 in the cluster communication network 10. The failure indication may include information such as identification of the node 82 or other cluster member, a cluster disband request if transmitted by the cluster head 80, a transmitter device to device identification, or a cluster identification.

In this cluster communication network 10 embodiment, the communication link shown as the lightning bolts between each node 82 and the cluster head 80 may comprise the connection between each of the nodes 82 and the cluster head 80. This communication link may comprise any means for connecting two electronic devices, including without limitation, a wired or wireless connection. The reception resources may comprise the partial or full connectivity of each node and cluster head with one another or the partial or full connectivity of each node and cluster head with a base station. In this embodiment, partial connectivity may result in the cluster head 80 or base station 12 communicating a message to remove a particular node 82 from the cluster, and full connectivity may comprise the cluster head 80 disbanding, or ceasing the communication link, with each node 82 in the network. Further, in this cluster communication network embodiment 10, reconfiguration of reception resources may comprise a change in the connectivity of any of the nodes 82 or the cluster head 80 with the cluster communication network. According to an example embodiment of the present invention, the nodes 82 in the cluster communication network 10 may comprise, without limitation, any electronic device configured to transfer information across a distance, including without limitation, computers and mobile terminals such as cellular telephones, dual mode cellular terminal or, any portable electronic device configured to communicate information electronically, or any telecommunications infrastructure such as base stations or other network entities.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
determining reception resources available for use by a first telecommunications device to monitor a communications link between the first telecommunications device and a second telecommunications device;
ascertaining the reception resources available for use by the second telecommunications device to monitor the communications link between the first telecommunications device and the second telecommunications device; and
selecting one of the first telecommunications device or the second telecommunications device as a monitoring device to monitor the communications link.

2. The method of claim 1, wherein selecting comprises selecting the first telecommunications device or the second telecommunications device as the monitoring device based at least in part on a balance of reception resources between the first telecommunications device and the second telecommunications device.

3. The method of claim 1, further comprising subsequently changing selection to the other of the first telecommunications device or the second telecommunications device as the monitoring device to monitor the communications link following initial selection of one of the first telecommunications device or the second telecommunications device.

4. The method of claim 3, wherein changing the selection to the other of the first telecommunications device or the second telecommunications device is based at least in part on a change in balance of reception resources of the first telecommunications device and the second telecommunications device.

5. The method of claim 3, wherein changing the selection of the other of the first telecommunications device or the second telecommunications device is performed in response to a message received from a base station in communication with the first telecommunications device and the second telecommunications device.

6. The method of claim 3, wherein changing the selection to the other of the first telecommunications device or the second telecommunications device is performed in response to at least one of the first telecommunications device or the second telecommunications device identifying a change in balance of reception resources of the first telecommunications device and the second telecommunications device.

7. The method of claim 3, wherein one of the first transmission device or the second transmission device serves as the monitoring device, wherein the other of the first telecommunications device or the second telecommunications devices serves as a subsequent monitoring device, and wherein the method further comprises causing timing information to be transferred from the monitoring device to the subsequent monitoring device.

8. The method of claim 1, wherein the first telecommunications device and the second telecommunications device comprise mobile terminals.

9. The method of claim 1, wherein the first telecommunications device or the second telecommunications device comprise a device used in a device-to-device connection.

10. The method of claim 1, wherein the first telecommunications device or the second telecommunications device comprise a device used in a device-to-device connection.

11. A method comprising:
monitoring at a first telecommunications device a communications link between the first telecommunications device and a second telecommunications device; and
changing responsibility for monitoring the communications link between the first telecommunications device and the second telecommunications device to the second telecommunications device.

12. The method of claim 11, wherein changing responsibility is based at least in part on available resources of the first telecommunications device and the second telecommunications device.

13. The method of claim 11, wherein changing responsibility is based at least in part on receiving a failure indication from a cluster head in a cluster communication network.

14. The method of claim 13, wherein receiving a failure indication from a cluster head in a cluster communication network is based at least in part on a communication link failure between nodes or a node and the cluster head.

15. The method of claim 11, wherein changing responsibility is based at least in part on receiving a failure indication based on a reference signal received from a cluster head in a cluster communication network.

16. The method of claim 11 further comprising identifying reception resources available for the first telecommunications device and the second telecommunications device prior to changing responsibility for monitoring the communications link.

17. The method of claim 11, further comprising causing timing information to be transferred from the first telecommunications device to the second telecommunications device.

18. The method of claim 11, wherein the first telecommunications device or the second telecommunications device comprise a device used in a device-to-device connection.

19. An apparatus comprising:
at least one processor; and
at least one memory including computer program code, the at least one memory and the computer program code configured to, with the at least one processor, cause the apparatus at least to:
determine reception resources available for use by a first telecommunications device to monitor a communications link between the first telecommunications device and a second telecommunications device;
ascertain the reception resources available for use by the second telecommunications device to monitor the communications link between the first telecommunications device and the second telecommunications device; and
select one of the first telecommunications device or the second telecommunications device as a monitoring device to monitor the communications link.

20. An apparatus according to claim 19 wherein the at least one memory and the computer program code are configured to, with the at least one processor, cause the apparatus to select one of the first telecommunications device or the second telecommunications device as a monitoring device to monitor the communications link by selecting the first telecommunications device or the second telecommunications device as the monitoring device based at least in part on the balance of reception resources of each of the first telecommunications device and the second telecommunications device.

21. An apparatus according to claim 19 wherein the at least one memory and the computer program code are configured to, with the at least one processor, cause the apparatus to identify a change in the balance of reception sources between the first telecommunications device or the second telecommunications device.

22. The apparatus of claim 21, wherein the at least one memory and the computer program code are configured to, with the at least one processor, cause the apparatus to select the other of the first telecommunications device or the second telecommunications device based at least in part on a change in balance of reception resources of the first telecommunications device and the second telecommunications device.

23. The apparatus of claim 21, wherein the at least one memory and the computer program code are configured to, with the at least one processor, cause the apparatus to select the other of the first telecommunications device or the second telecommunications device in response to a message received from a base station in communication with the first telecommunications device and the second telecommunications device.

24. The apparatus of claim 21, wherein the at least one memory and the computer program code are configured to, with the at least one processor, cause the apparatus to select the other of the first telecommunications device or the second telecommunications device in response to a change in balance of reception resources of the first telecommunications device and the second telecommunications device.

25. The apparatus of claim 21, wherein one of the first telecommunications device or the second telecommunications device serves as the monitoring device, wherein the other of the first telecommunications device or the second telecommunications devices serves as a subsequent monitoring device, and wherein the at least one memory and the computer program code are further configured to, with the at least one processor, cause the apparatus to cause timing information to be transferred from the monitoring device to the subsequent monitoring device.

26. An apparatus according to claim 19, wherein the first telecommunications device and the second telecommunications device comprise mobile terminals.

27. An apparatus according to claim 19, wherein said apparatus comprises a mobile terminal.

28. An apparatus according to claim 19, wherein said apparatus comprises a base station in a telecommunications network.

29. An apparatus according to claim 19, wherein said apparatus is a device used in a device-to-device connection.

30. The apparatus according to claim 19, wherein said apparatus may comprise the first telecommunications device or the second telecommunications device.
